(19) United States
(12) Patent Application Publication
(10) Pub. No.: US 2008/0018920 A1
(43) Pub. Date: Jan. 24, 2008

(54) IMAGE PROCESSING APPARATUS

(76) Inventors: Hiroyuki KAWAMOTO, Kanagawa (JP); Satoshi Ohkawa, Tokyo (JP); Atsushi Togami, Kanagawa (JP); Tomoyuki Yoshida, Tokyo (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/774,178

(22) Filed: Jul. 6, 2007

(30) Foreign Application Priority Data
Jul. 19, 2006 (JP) 2006-197128

(51) Int. Cl. G06F 15/00

(52) U.S. Cl. 358/1.9; 358/1.16

(57) ABSTRACT

An image processing apparatus in which an image obtained by image reading can be printed or used in another apparatus in a state identical to the appearance of the image when displayed. A first image correction unit converts image data inputted through an image reading unit into standard image data that can be shared by a plurality of types of output destinations, and generates image area separation information through image area separation judgment of the image data. The converted image data is associated with the generated image area separation information and both are stored in an image storage unit. An image editing unit edits the stored image data, and a second image correction unit converts the image data to image data for an image display unit as an output destination, while a third image correction unit converts the image data to image data for an image forming unit as an output destination.

### BACKGROUND OF THE INVENTION

1. Field of the Invention

The present invention relates to an image processing apparatus comprising a copier, a facsimile and a scanner for performing various processes on image data, to an image processing method carried out in the image processing apparatus, for performing various processes on image data, and to a program for causing a computer to execute a procedure for performing various processes on image data.

2. Description of the Related Art

Japanese Unexamined Patent Application Laid-open No. 2003-101797, for instance, discloses a conventional image processing apparatus comprising a copier, a facsimile and a scanner, wherein a read image is displayed on a display screen of an operative unit, the content of the image is verified, and then printing is carried out on the basis of the read image data.

Such a conventional image processing apparatus, however, is problematic in that color during display of the image read from an original is completely different from color during display, during printing, and during display and/or printing in the device to which the image is outputted.

Technologies relating to the present invention are also disclosed in, e.g., Japanese Unexamined Patent Application Laid-open No. 2004-040784.

### SUMMARY OF THE INVENTION

In light of the above, it is an object of the present invention to provide an image processing apparatus in which an image obtained by image reading can be printed and/or used in another apparatus in a state identical to the appearance of the image when displayed, to provide an image processing method carried out in the image processing apparatus, for performing various processes on image data, and to provide a program for causing a computer to execute a procedure for performing various processes on image data.

In an aspect of the present invention, an image processing apparatus comprises an image input device for inputting image data; a first image conversion device for converting the image data inputted by the image input device into standard image data that can be shared by a plurality of types of output destinations, and for generating image area separation information through image area separation judgment of the image data; an image storage device for associating and storing the image data converted by the first image conversion device and the generated image area separation information; an image editing device for editing the image data stored in the image storage device; and a second image conversion device for converting the image data edited by the image editing device into image data for use in a display device as an output destination.

In another aspect of the present invention, an image processing method comprises an image input step of inputting image data; a first image conversion step of converting the image data inputted in the image input step into standard image data that can be shared by a plurality of types of output destinations, and of generating image area separation information through image area separation judgment of the image data; an image storage step of associating and storing the image data converted in the first image conversion step and the generated image area separation information; an image editing step of editing the image data stored in the image storage step; and a second image conversion step of converting the image data edited in the image editing step into image data for use in a display device as an output destination.

In another aspect of the present invention, a program causes a computer to execute an image processing function. The image processing function comprises an image input procedure of inputting image data; a first image conversion procedure of converting the image data inputted in the image input procedure into standard image data that can be shared by a plurality of types of output destinations, and of generating image area separation information through image area separation judgment of the image data; an image storage procedure of associating and storing the image data converted in the first image conversion procedure and the generated image area separation information; an image editing procedure of editing the image data stored in the image storage procedure; and a second image conversion procedure of converting the image data edited in the image editing procedure into image data for use in a display device as an output destination.

### BRIEF DESCRIPTION OF THE DRAWINGS

The above and other objects, features and advantages of the present invention will become more apparent from the following detailed description taken with the accompanying drawings in which:

FIG. 1 is a block diagram illustrating the functional constitution of a digital multifunction machine in an embodiment of the present invention;

FIGS. 2 through 5 are block diagrams illustrating, respectively, the inner constitutions of a first through a fourth image correction unit of the digital multifunction machine illustrated in FIG. 1;

FIG. 6 is a block diagram explaining another function of the digital multifunction machine;

FIG. 7 is a block diagram illustrating another example of the internal constitution of the second image correction unit;

FIG. 8 is a block diagram illustrating another further example of the internal constitution of the second image correction unit;

FIG. 9 is a block diagram illustrating yet another further example of the internal constitution of the second image correction unit;

FIG. 10 is a block diagram illustrating still yet another further example of the internal constitution of the second image correction unit; and

FIGS. 11A and 11B are diagrams explaining an example of compression computation processing of image data.

### DESCRIPTION OF THE PREFERRED EMBODIMENTS

An embodiment of the present invention is explained in detail next with reference to accompanying drawings.

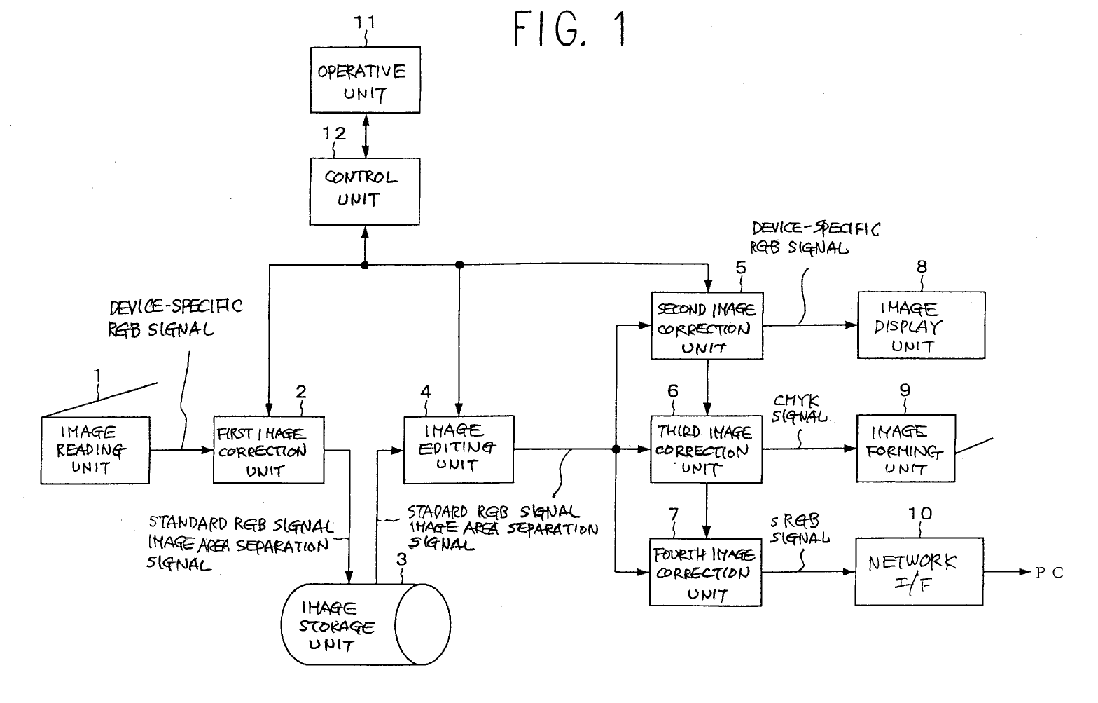

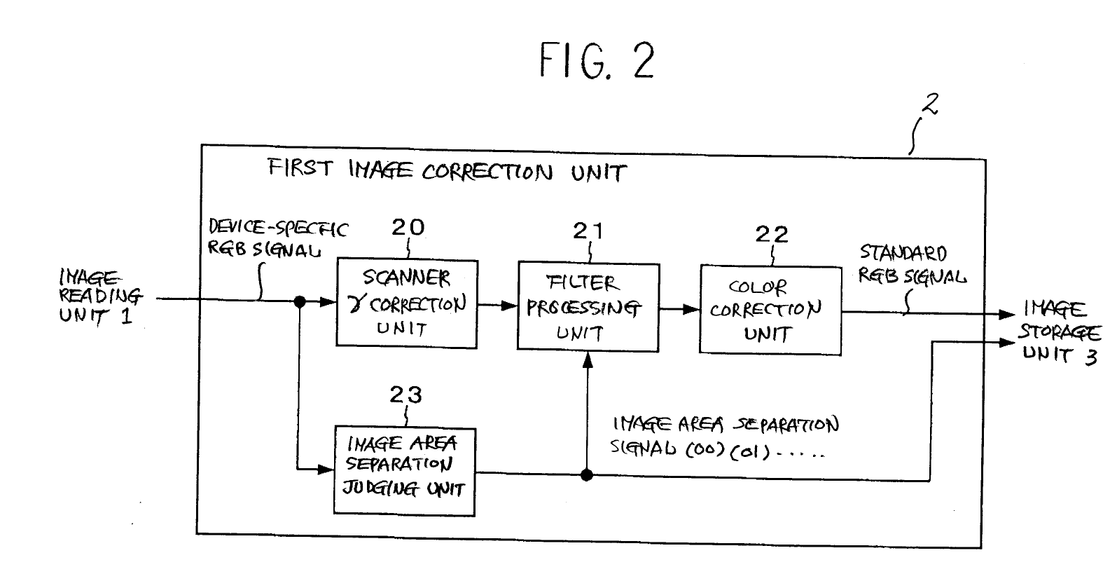

FIG. 1 illustrates the functional constitution of a digital multifunction machine (“MFP” for short) according to the present embodiment, while FIGS. 2 through 5 illustrate, respectively, the inner constitutions of a first image correction unit 2 shown in FIG. 1, a second image correction unit 5 shown in FIG. 1, a third image correction unit 6 shown in FIG. 1, and a fourth image correction unit 7 shown in FIG. 1.

The MFP is an image processing apparatus comprising a digital multifunction machine for carrying out monitor display output of image data of an image read from an original, carrying out paper output, and carrying out a distribution application for distributing data to a terminal device via a network. In the MFP, the functions of the below-described various means are performed by carrying out an image processing method that comprises installing in a microcomputer a program for executing an image input procedure, a first image conversion procedure, an image storage procedure, an image edit procedure and a second image conversion procedure, and executing that program.

In the MFP, as illustrated in FIG. 1, a control unit 12 controls the various units, an image reading unit 1, being herein a scanner, reads images from an original, and sends RGB image data based on the read image to the first image correction unit 2, using a device-specific RGB signal of the image reading unit 1. The image reading unit 1 corresponds to the image input means.

As illustrated in FIG. 2, processing in the first image correction unit 2 is carried out by a scanner γ correction unit 20, a filter processing unit 21, and a color correction unit 22. The first image correction unit 2 corresponds to the first image conversion means.

In the scanner γ correction unit 20 the device-specific RGB signal image data is corrected based on a reference table (Look-up table: LUT) of input 8-bit and output 8-bit for each RGB channel. In the filter processing unit 21 the image data is subjected to spatial filter processing based on a matrix of about 5×5. In the color correction unit 22, the inputted RGB image data is subjected to linear transformation, on the basis of a 3×3 matrix, into RGB image data for output. This conversion can also be carried out using a three-dimensional LUT. Standard RGB signal image data is then outputted to the image storage unit 3.

The image data is also inputted to an image area separation judging unit 23 where the image data is subjected to image area separation judging on the basis of an image area separation judgment algorithm.

In this image area separation judging process it is judged whether an object pixel in the image data is black or of a color other than black, and simultaneously, whether the object pixel is a character or non-character pixel (halftone dot, solid, background), such that a signal b(00) for black character, a signal b(01) for black non-character, a signal b(10) for color character, and a signal b(11) for color non-character are respectively outputted, as image area separation signals (image area separation information), to the image storage unit 3.

The device-specific RGB signal image data read by the image reading unit 1 is inputted to the first image correction unit 2 of FIG. 1, from which it is outputted as image data where the device-specific RGB signal image data has been converted into a standard RGB signal color in a color space shared by the various devices. Conversion into a common color space is carried out herein with the purpose of re-using the image data.

Standard RGB signal image data after this conversion is associated with the image area separation signal and both are stored in the image storage unit 3. The image storage unit 3 corresponds to the image storage means. The image storage unit 3 is a storage device comprising, for instance, a mass-storage device not shown in the figure, equipped with a compression-decompression device, a semiconductor memory, and a hard disk or the like. Such a storage device is well known, and hence a detailed description thereof will be omitted here.

Next, the image data and the image area separation signal are read out from the image storage unit 3 of FIG. 1 and are sent to an image editing unit 4, where the image data is subjected to various editing processes such as density adjustment, color conversion, translation, rotation and resolution conversion. The image editing unit 4 corresponds to the image editing means.

Since image edit processing is well known, a detailed explanation thereof is omitted here. In broad terms, however, image editing can be divided into adjustment of color, including density adjustment, color conversion and the like, and transformation of the image address, including image translation, rotation and the like. The process under consideration herein is image editing relating to color.

The image data and the image area separation signal outputted from the image editing unit 4 are sent respectively to the second image correction unit 5, the third image correction unit 6 and the fourth image correction unit 7, where they are converted into color spaces that conform to the devices that are the output destinations of the image data.

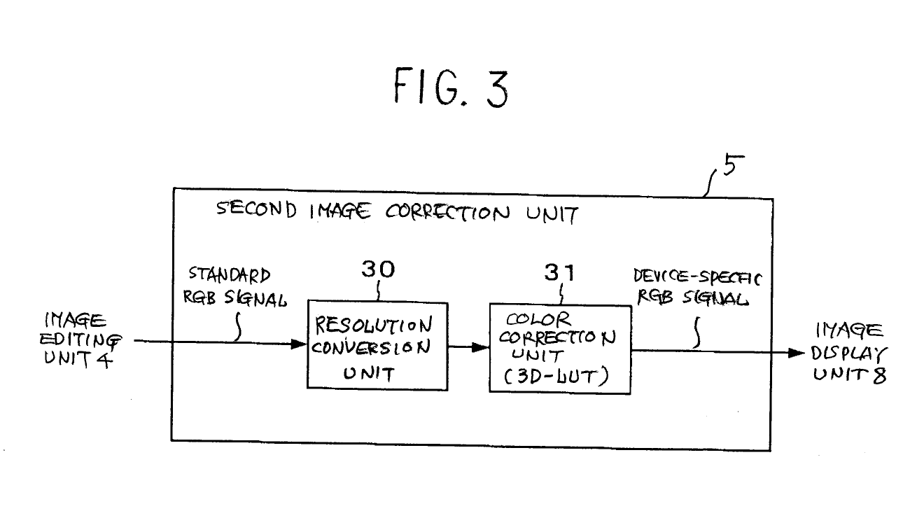

The second image correction unit 5 of FIG. 1 converts image data for image display on the image display unit 8. The image display unit 8 is a monitor comprising a CRT or LCD, which is a relatively small display device, installed on the operative unit 11. The second image correction unit 5 corresponds to the second image conversion means. As illustrated in FIG. 3, the second image correction unit 5 comprises a resolution conversion unit 30 for resolution conversion processing of standard RGB signal image data inputted from the image editing unit 4, and a color correction unit 31 for color correction of the converted image data. In the second image correction unit 5 is thus carried out a process for converting the image data to image data (image data for the image display unit 8) suitable for the image display unit 8 that is the output destination.

The resolution conversion process carried out in the resolution conversion unit 30 is a process comprising image expansion/contraction in accordance with a well-known technology such as three-dimensional function convolution.

The color correction process carried out in the color correction unit 31 comprises, for instance, conversion from a standard RGB color space to a color space that conforms to the display capabilities of the image display unit 8, using 3D-LUT color correction.

The third image correction unit 6 of FIG. 1 carries out image data conversion for outputting image data to an image forming unit 9 comprising a laser printer equipped with an image forming unit engine for forming an image to be printed on paper.

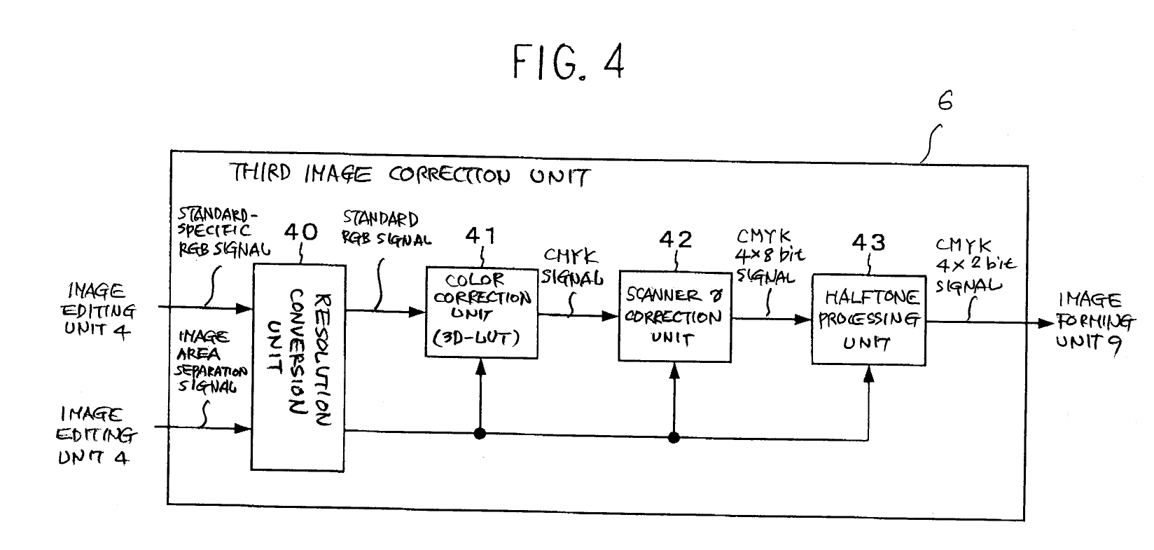

As illustrated in FIG. 4, the third image correction unit 6, in which image data is processed to become suitable for output on paper, comprises a resolution conversion unit 40 for resolution conversion processing of standard RGB signal image data inputted from the image editing unit 4, on the basis of the image area separation signal inputted from the image editing unit 4, a color correction unit 41 for correcting the color of the converted image data and outputting CMYK signal image data, a printer γ correction unit 42 for performing gamma correction for printer use on the corrected image data, and for outputting 4×8 bit CMYK signal image data, and a halftone processing unit 43 for halftone processing of the corrected image data and for outputting 4×2 bit CMYK signal image data.

The resolution conversion process carried out in the resolution conversion unit 40 comprises image expansion/contraction in accordance with a well-known technology such as three-dimensional function convolution. The color correction process carried out in the color correction unit 41 comprises conversion from a standard RGB color space to a color space that conforms to the image forming unit 9, in this case conversion to a CMYK signal. In the halftone process carried out in the halftone processing unit 43 is performed conversion to a low-bit signal for printing on paper, by means of a well-known technology such as error diffusion, dithering or the like.

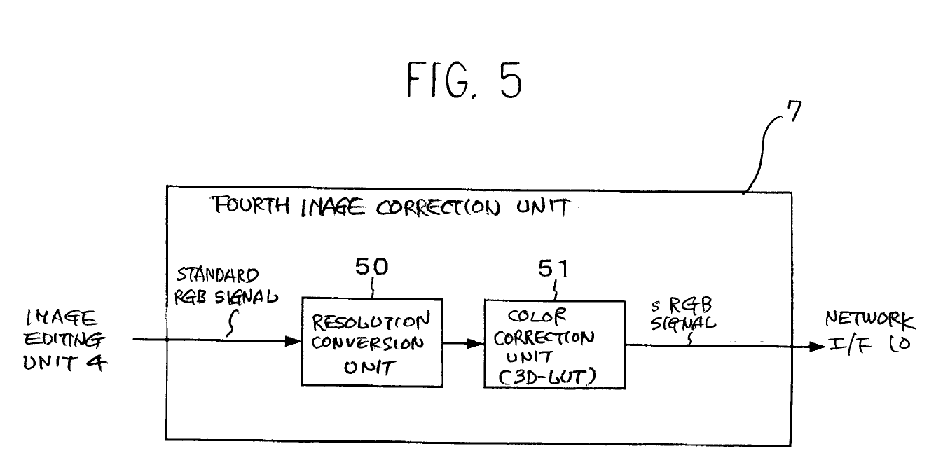

The fourth image correction unit 7 illustrated in FIG. 1 converts image data to electronic data for transmission to a terminal device on a network via a network interface (I/F) 10. The fourth image correction unit 7, which converts image data to image data suitable for use as an electronic image to be sent to a terminal device on a network, comprises, as illustrated in FIG. 5, a resolution conversion unit 50 for resolution conversion processing of standard RGB signal image data inputted from the image editing unit 4, and a color correction unit 51 for color correction of the converted image data.

The resolution conversion process carried out in the resolution conversion unit 50 comprises image expansion/contraction in accordance with a well-known technology such as three-dimensional function convolution. The color correction carried out in the color correction unit 51 comprises, for instance, conversion from a standard RGB color space to a color space conforming to the terminal device that is the output destination via the network I/F 10, using 3D-LUT color correction. This may be, for instance, conversion to sRGB signal image data.

Although the internal constitution of the second image correction unit 5 and the fourth image correction unit 7 as depicted are identical, there are differences in the details of their actual constitutions.

In the second image correction unit 5, image data is converted to image data that is displayed for pre-confirmation in the MFP, prior to output of the image data to the image forming unit 9 or a PC. In the fourth image correction unit 7, by contrast, it is assumed that the image data is transferred to a PC on a network, where it is used, on the assumption that image data is used in the PC at a relatively high resolution. Hence the required functionalities in these two image correction units are different.

In the MFP, the operative unit 11 instructs the content of the desired editing for the image data stored in the image storage unit 3. This instruction is forwarded to the image editing unit 4 via the control unit 12.

When an instruction from the operative unit 11 is a preview (pre-confirmation), the second image correction unit 5 causes to be displayed on the image display unit 8 an image that reflects the content of the edit process of the image editing unit 4. When the edit content is unsatisfactory, the user prompts preview through another instruction from the operative unit 11. When the edit content is satisfactory, the image data after editing is outputted to the image forming unit 9 based on an instruction from the operative unit 11 prompted by the user.

It becomes thus possible to store image data, edit the image data, and display the edited image data on the image display unit 8 prior to output of the edited image data to the image forming unit 9. Also, the image data after image edit can be used collectively for display, for output in the image forming unit 9, and for transmission to a scanner application, whereby image data can be printed or electronically distributed with the same image quality as viewed on the image display unit 8.

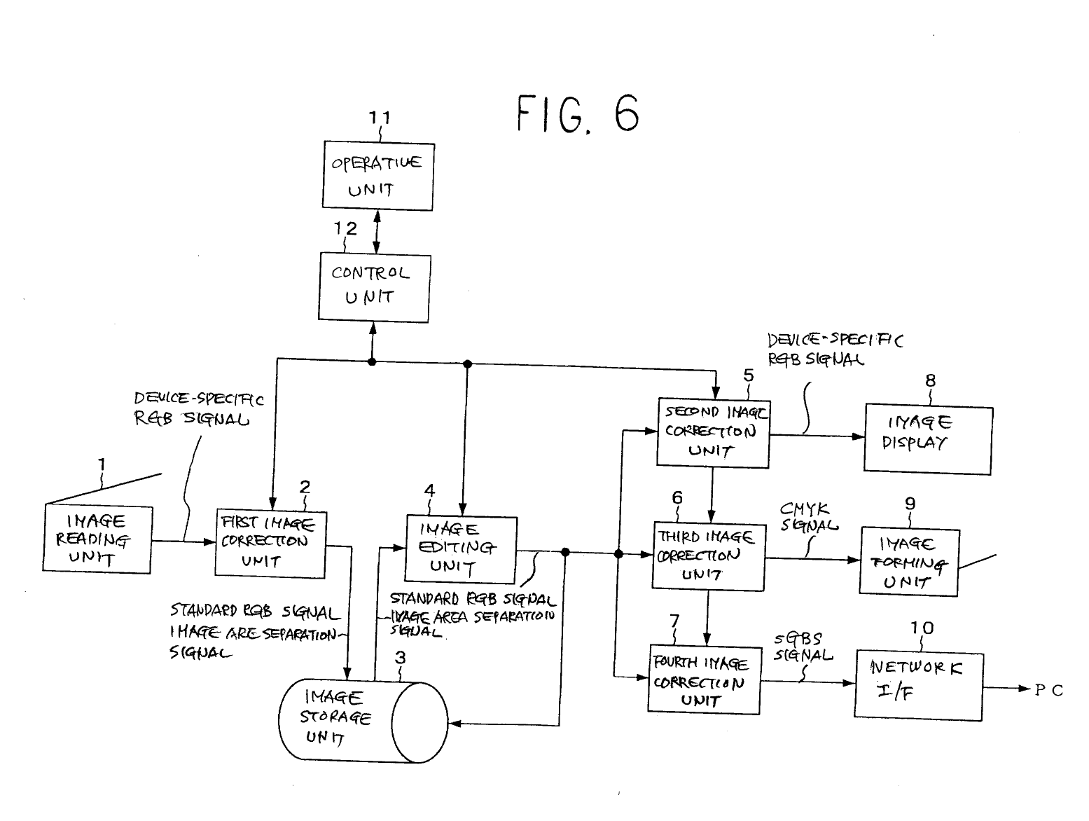

In the MFP, the image data after image editing may be stored again in the image storage unit 3. That is, the image data after being edited in the image editing unit 4 is stored in the image storage unit 3, as illustrated in FIG. 6. Herein, the image data after editing may be stored associated to the image data before editing. Upon storage of the image data in the image storage unit 3, the image content after editing is simultaneously preview-displayed on the image display unit 8, based on the image data after editing.

If the previewed image content is non-problematic, thus, the image data after editing, which is stored in the image storage unit 3, can be outputted without modification.

A substantial improvement in productivity can be achieved as a result, when that image editing is not processed in real time, as in a CPU or the like. Also, the content after editing stored in the image storage unit 3 can be repeatedly edited any number of times.

Storing again image data after image editing and displaying the image data on the image display unit enables thus repeated editing over several times and verification of the image content each time.

Since the image data after image editing is stored in the image storage unit 3, the image data after image editing can be processed and outputted by the third image correction unit 6 and the fourth image correction unit 7 without having to be edited again, affording thus high-speed processing.

The process of the above preview display operation is preferably completed quickly after an instruction by the user. That is because a rapid operation is required irrespective of the speed of original image reading in the image reading unit 1 or of the printing speed in the image forming unit 9. Hence, color correction in the above second image correction unit should be carried out speedily and using a simple constitution.

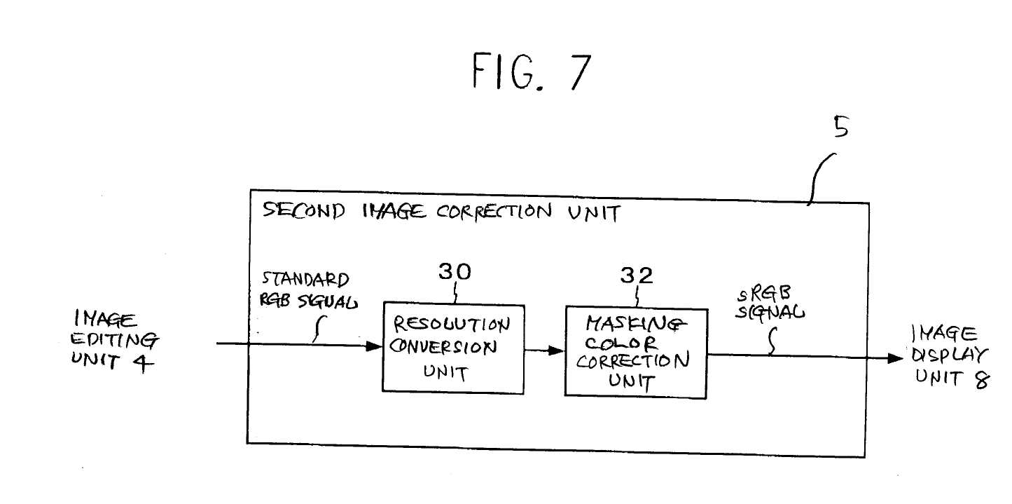

FIG. 7 illustrates another example of the internal constitution of the second image correction unit 5 illustrated in FIG. 1.

In this second image correction unit 5, there is provided a masking color correction unit 32 for color correction by a matrix operation using a matrix of about 3×3, instead of the above color correction unit 31, such that the image data edited by the image editing unit 4 is converted into image data that is color-corrected on the basis of the resolution to be used in the image display unit 8, which is the output destination, and on the basis of the masking computation.

Thus, the image data after resolution conversion by the resolution conversion unit 30 is subjected to color correction in a simple circuit having a high processing speed, or using an algorithm, which allows reducing the computational burden and displaying speedily a preview of the image. A constitution having a function for immediate display of an edited image can thus be realized at a low cost.

Ordinarily, color reproduction ranges differ for the image forming unit 9 and the sRGB signal image data.

In the second image correction unit 5, therefore, color conversion is carried out based on the color range that corresponds to the output destination, as instructed by the operative unit 11, to enable thereby a high-precision match between the printed or electronically distributed output image and the display image. Using 3D-LUT for color correction in the color correction unit 31 of the second image correction unit 5 allows converting image data to any color space simply by modifying the parameters of the 3D-LUT.

Accordingly, the output image and the display image can be matched by modifying the parameters of the 3D-LUT following an instruction by the operative unit 11.

Thus, the color of the display image, the color of the print image as well as the color of the display image or print image at the electronic distribution destination can be matched by modifying the color correction parameters of the color correction unit for display, depending on the output destinations, i.e. the image forming unit and the network I/F, and by performing color correction taking into account the color reproduction ranges of the devices that are the output destinations.

In the third image correction unit 6, ordinarily, the parameters of internal color conversion are modified depending on whether the judgment result of the image area separation judgment, based on the image separation signal bn, is a black character, a black non-character, a color character or a color non-character. That is because color characters are preferably reproduced vividly, but non-character portions are preferably reproduced in natural hues.

Therefore, the color conversion parameters must be changed in accordance with the image area separation signal bn, also during color conversion in the second image correction unit 5, in order to match the color of the image data of the image outputted to the image forming unit 9 or the network, with the color of the image of the image data outputted to the image display unit 8.

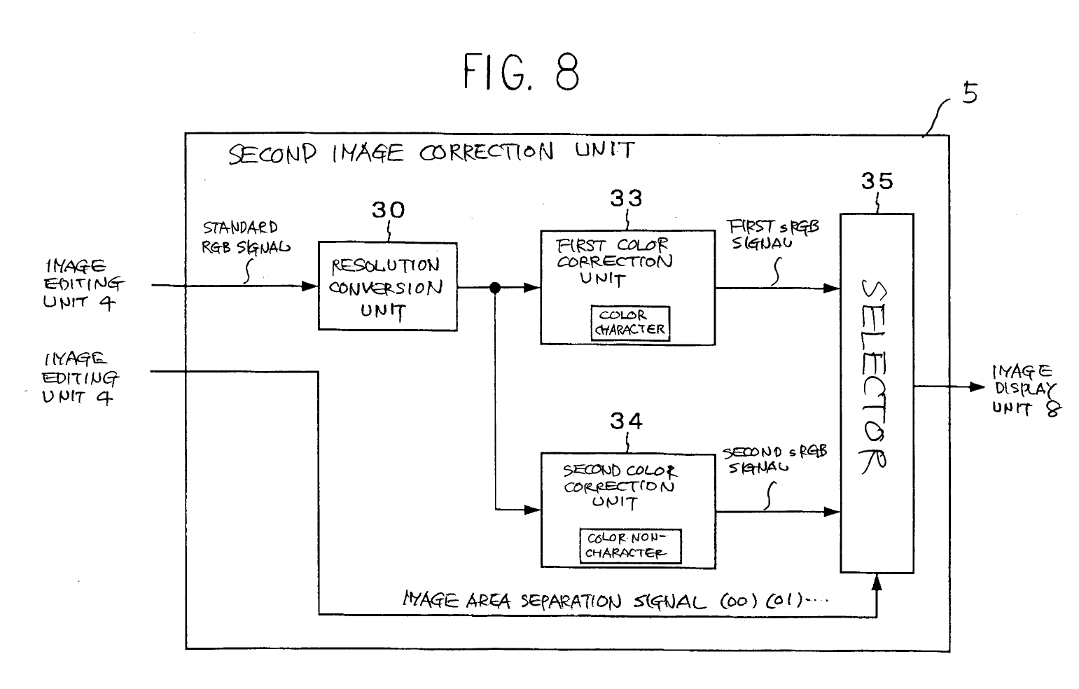

FIG. 8 is a block diagram illustrating another further example of the internal constitution of the second image correction unit 5 illustrated in FIG. 1. This second image correction unit 5 comprises a first color correction unit 33, a second color correction unit 34 and a selector 35, instead of the above-described color correction unit 31.

In the first color correction unit 33 and the second color correction unit 34 there are set different parameters, such that the first color correction unit 33 outputs first sRGB signal image data resulting from 3D-LUT conversion of the image data outputted from the resolution conversion unit 30, on the basis of first parameters (for instance, parameters of color character). The second color correction unit 34 outputs second sRGB signal image data resulting from 3D-LUT conversion of the image data outputted from the resolution conversion unit 30, on the basis of second parameters (for instance, parameters of color non-character).

Based on the content of the image area separation signal, the selector 35 outputs to the image display unit 8 either the first sRGB signal image data or the second sRGB signal image data, whereby the image data edited by the image editing unit 4 is converted to resolution for output in the image forming unit 9 or the network, and is converted into image data that is color-corrected based on the color correction parameters that differ for output to the image forming unit 9 and for output to the network.

In the third image correction unit 6, thus, the color correction parameters are switched based on the result of the image area separation signal, while in the second image correction unit 5, likewise, the color correction parameters for display are switched based on the image area separation signal. Accordingly, process carried out in accordance with the foregoing enables high-precision matching of the print image and the display image.

The above image display unit 8 has ordinarily a size of about 640×480 pixels. On the other hand, the stored image data has an A4 size with about 9000×7000 pixels. Thus, display is impossible unless the image data is subjected to resolution conversion with a large compression ratio. The stored image data, moreover, is the image data read by the image reading unit 1; accordingly, when there are halftone dot portions in the original, the relief of the halftone dots remains in the stored image data, so that compression by thinning of the unmodified image data can result in the occurrence of an extreme moiré effect.

Herein, strong smoothing may be carried out, although it is possible that the image may be blurred, allowing no crisp viewing, if the display area of the image display unit 8 is small.

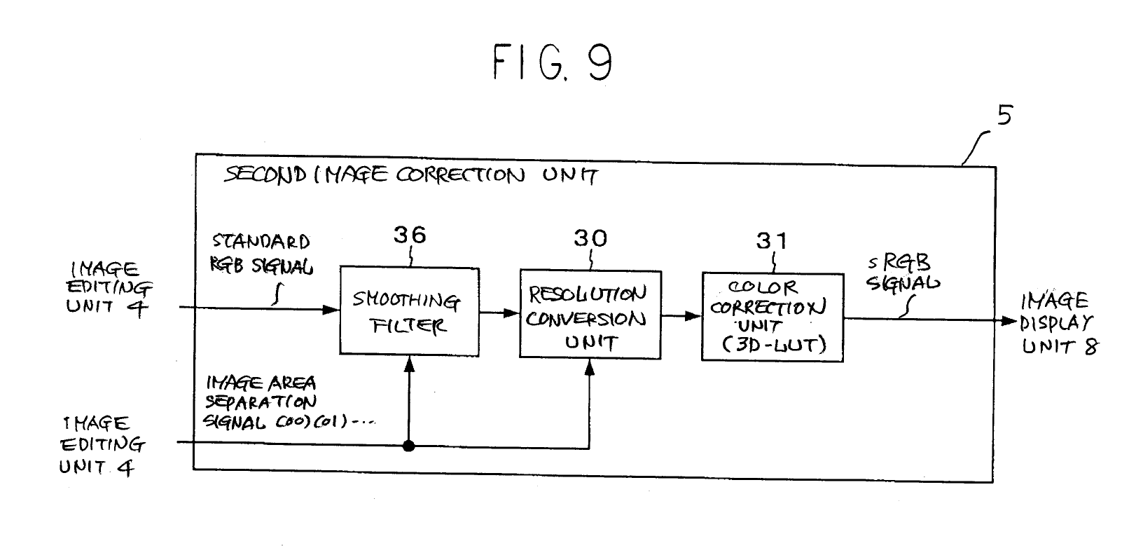

FIG. 9 illustrates yet another further example of the internal constitution of the second image correction unit 5 illustrated in FIG. 1.

This second image correction unit 5 comprises a smoothing filter 36 before the resolution conversion unit 30, such that respective interpolation coefficients of the smoothing filter 36 and the resolution conversion unit 30 are switched based on the image area separation signal. The image data edited by the image editing unit 4 is converted to image data having been subjected to smoothing filtering using an interpolation coefficient that is modified based on image area separation information corresponding to the image data, to resolution conversion using an interpolation coefficient modified based on the image area separation information, and to color correction.

This allows generating an image free of moiré patterns in the halftone dot portions of the image, and without loss of resolution in character portions.

Thus, modifying the interpolation coefficient in the resolution conversion unit based on the image area separation signal and on the conversion resolution allows generating, during expansion, a faithful image of portions judged to be non-character portions, and during compression, generating images with suppressed moiré effect, while preserving the resolution of portions judged to be character portions.

The occurrence of a moiré effect in halftone dots in the image is suppressed in the above process, although such a process may be impractical for characters, on account of character blurring or fading. Herein, the reduction operation method in the resolution conversion unit may be switched to another method based on the image area separation signal.

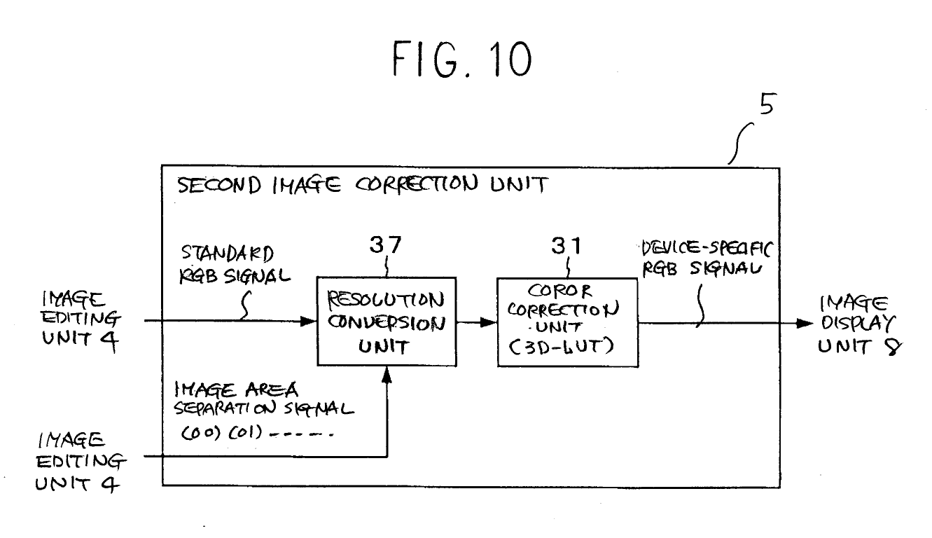

FIG. 10 illustrates still yet another further example of the internal constitution of the second image correction unit 5 illustrated in FIG. 1.

This second image correction unit 5 comprises a resolution conversion unit 37 for resolution conversion of the image data edited by the image editing unit 4, based on an image area separation signal, such that the image data edited by the image editing unit 4 is converted to image data having been subjected to resolution conversion using a resolution conversion method modified based on the image area separation information corresponding to that image data, and to color correction. In the resolution conversion unit 37, the image data is subjected to resolution conversion by switching between reduction operation methods on the basis of the image area separation signal.

The above reduction operation method has the problem of information loss through compression of portions in the image judged to be characters, and hence loss of characters and/or lines is prevented by carrying out OR processing among the pixels to be thinned, followed by pixel thinning.

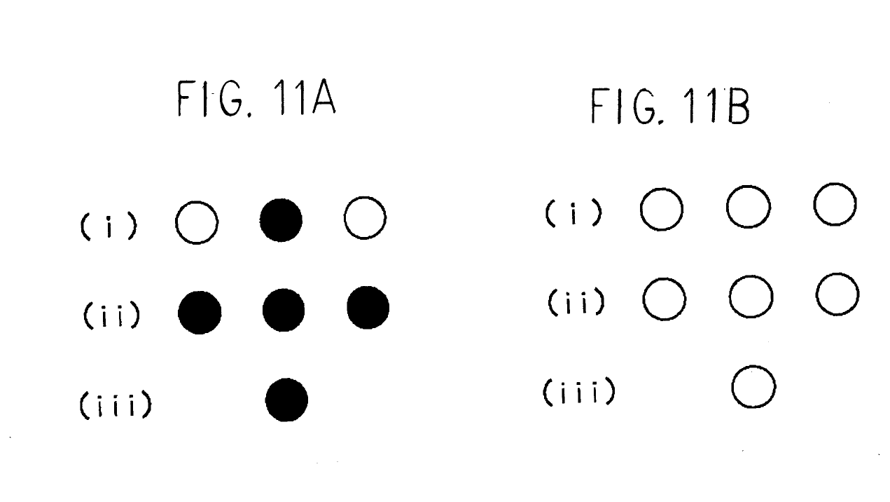

An example of compression computation processing of image data will be explained next with reference to FIGS. 11A and 11B.

In the case, for instance, of correction of the image data resolution from 600 dpi to 200 dpi, when both end pixels of three consecutive pixels are white pixels and the middle pixel is black, as illustrated by (i) in FIG. 11A, all the pixels are converted into black pixels, as illustrated in (ii), after which two pixels are thinned to leave one remaining black pixel, as illustrated in (iii).

Meanwhile, in the case of three consecutive pixels being all white, as illustrated b7 (i) in FIG. 11B, all the white pixels are left unchanged, as illustrated in (ii), and then two pixels are thinned to leave one remaining white pixel, as illustrated in (iii).

For the non-character portions of the image, carrying out compression computation using a well-known technology such as three-dimensional function convolution allows generating a display image without information loss, even during compression of character portions.

During image display of image data compressed in the second image correction unit, thus, carrying out OR-thinning compression in character portions, and an ordinary interpolation computation in other portions, allows obtaining a display image having no loss in character portions and being faithful to the output image in other portions.

As explained above, thus, the image processing apparatus and image processing method according to the present invention allow providing an image processing apparatus in which an image obtained by image reading can be printed or used in another apparatus in a state identical to the appearance of the image when displayed. Also, the program according to the present invention allows realizing a function that enables printing, or using in another device, of an image in a state identical to the appearance of the image, obtained by image reading, when displayed on a computer.

Various modifications will become possible for those skilled in the art after receiving the teachings of the present disclosure without departing from the scope thereof.

What is claimed is:

1. An image processing apparatus, comprising:
image input means for inputting image data;
first image conversion means for converting the image data inputted by the image input means into standard image data that can be shared by a plurality of types of output destinations, and for generating image area separation information through image area separation judgment of said image data;
image storage means for associating and storing the image data converted by the first image conversion means and said generated image area separation information;
image editing means for editing the image data stored in the image storage means; and
second image conversion means for converting the image data edited by the image editing means into image data for use in a display device as an output destination.

2. The image processing apparatus as claimed in claim 1, further comprising storage means for storing in said image storage means image data edited by said image editing means.

3. The image processing apparatus as claimed in claim 1, wherein said second image conversion means is means for converting the image data edited by said image editing means into resolution for a display device as an output destination, and into image data that is color-corrected based on a masking computation.

4. The image processing apparatus as claimed in claim 1, wherein said second image conversion means is means for converting the image data edited by said image editing means into resolution for output to a printing device or a network, and into color-corrected image data using color correction parameters differing for output to said printing device and for output to said network.

5. The image processing apparatus as claimed in claim 1, wherein said second image conversion means is means for converting the image data edited by said image editing means into resolution for a display device as an output destination, and into color-corrected image data using color correction parameters modified on the basis of image area separation information corresponding to said image data.

6. The image processing apparatus as claimed in claim 1, wherein said second image conversion means is means for converting the image data edited by said image editing means into resolution using an interpolation coefficient modified on the basis of image area separation information corresponding to said image data, and into color-corrected image data.

7. The image processing apparatus as claimed in claim 1, wherein said second image conversion means is means for converting the image data edited by said image editing means into resolution using a resolution conversion method modified on the basis of image area separation information corresponding to said image data, and into color-corrected image data.

8. An image processing method, comprising:
an image input step of inputting image data;
a first image conversion step of converting the image data inputted in the image input step into standard image data that can be shared by a plurality of types of output destinations, and of generating image area separation information through image area separation judgment of said image data;
an image storage step of associating and storing the image data converted in the first image conversion step and said generated image area separation information;
an image editing step of editing the image data stored in the image storage step; and
a second image conversion step of converting the image data edited in the image editing step into image data for use in a display device as an output destination.

9. A program for causing a computer to execute an image processing function, the image processing function comprising:
an image input procedure of inputting image data;
a first image conversion procedure of converting the image data inputted in the image input procedure into standard image data that can be shared by a plurality of types of output destinations, and of generating image area separation information through image area separation judgment of said image data;
an image storage procedure of associating and storing the image data converted in the first image conversion procedure and said generated image area separation information;
an image editing procedure of editing the image data stored in the image storage procedure; and
a second image conversion procedure of converting the image data edited in the image editing procedure into image data for use in a display device as an output destination.
